(19) United States
(12) Patent Application Publication
(10) Pub. No.: US 2025/0344664 A1
(43) Pub. Date: Nov. 13, 2025

(54) DEODORANT DEVICE FOR A PET LITTER BOX AND METHOD OF ELIMINATING ODORS FOR A LITTER BOX

(71) Applicant: Ferplast S.p.A., Castelgomberto (IT)

(72) Inventor: Nicola Vaccari, Castelgomberto (IT)

(21) Appl. No.: 19/200,160

(22) Filed: May 6, 2025

(30) Foreign Application Priority Data
May 7, 2024 (IT) 102024000010201

(51) Int. Cl. A01K 1/00; A01K 1/01

(52) U.S. Cl. CPC A01K 1/0052; A01K 1/0107

(57) ABSTRACT

A deodorant device for a pet litter box comprises a suction body, having at least one inlet opening and at least one outlet opening, an odor eliminating device, activatable on a first airflow to be processed to eliminate an odor present therein, generating a processed second airflow, further comprising a suction fan, configured to draw in the first airflow to be processed from the pet litter box through the inlet opening and emit the processed second airflow through the outlet opening. Furthermore, the deodorant device comprises a control unit operatively associated with a presence sensor and configured to activate the suction fan as a function of the presence signal, particularly after the pet has come out of the pet litter box, and to deactivate the suction fan as a function of a presence signal from the presence sensor to prevent the operation of the suction fan while a pet is present inside the pet litter box.

### TECHNICAL FIELD

The present invention relates to a deodorant device for a pet litter box and method of eliminating odors for a pet litter box.

In particular, deodorant devices are configured to manage odors coming from a litter box generally due to pet droppings so as to eliminate unpleasant odors, contributing to make the litter box a more comfortable environment for pets. Such devices play an important role in maintaining a healthier environment for both the pets and the owners.

Furthermore, the deodorant devices help to prevent the risk of litter box rejection as pets, in particular cats, tend to avoid the use of litter boxes due to the presence of unpleasant odors.

### BACKGROUND ART

There are different types of deodorant devices on the market today.

For example, ozone deodorant devices allow odors to be eliminated by introducing ozone into the air. Although ozone is effective in eliminating odors, it is, however, very harmful to both human and pet health.

There are also air ionisation deodorant devices. However, such devices are subject to the accumulation of electrostatic energy which can discharge on the pet, frightening it and increasing the risk of litter box rejection. In addition, the ionisation devices can produce ozone as a by-product and, as previously highlighted, be harmful to the health of the pet.

Some alternative solutions may involve the use of activated carbon through which the air is made to flow to eliminate the odors contained therein and subsequently introduced back into the litter box.

Disadvantageously, such devices have quite big dimensions which determine the need for fixing them to the upper wall of the litter box or cage, thus limiting the spaces for the pet's movement. In particular, the dimensions of such devices severely limit their adaptability to the different conformations of litter boxes and cages.

Disadvantageously, moreover, the performance of such devices is severely limited, as they are not able to generate an effective mixing of the air reintroduced with the air already present in the litter box or in the cage.

Furthermore, very disadvantageously, the noise and vibrations induced by the movement of the air caused by such devices strongly disturb the pet, frightening it and causing it to irretrievably reject the litter box.

Document US 2010/180830 A1, with its abstract, discloses a portable deodorizing air treatment device adaptable for use in a litter box. The device is activated by the presence of the pet in the litter box. After the pet uses the box, the device intakes dirty air, treats it with odor-absorbing activated carbon and optionally fragrance, expelling clean unscented or scented air.

Document KR 20180000317 U discloses a ventilation device for a cat's toilet which is provided with a ventilation hole in the upper ceiling and can be used by being combined integrally or detachably on a housing body of a cat toilet on the floor surface of which sand is loaded. The ventilation device comprises: a ventilation drive means, a first odor discharge hose which has one end integrally or detachably connected to the ventilation hole of the housing body and the other end connected to the ventilation drive means. It includes a second odor exhaust hose which is connected at one end to the ventilation drive means and the other end is exposed to the outside by penetrating through a hole made in the lower window frame that supports the window. When a cat defecates inside the housing body, the odor generated by the cat defecating inside the housing body is inhaled and discharged to the outside through the window through the operation of the ventilation drive means thereby allowing immediate ventilation.

Document U.S. Pat. No. 5,511,513 A, with its abstract, discloses a pet waste material collector and odor eliminator system having in combination a rectangular container, a removable tray insertable in said container which holds litter material and has vents disposed around the upper vertical portions thereof, a filter pack, a fragrance dispenser, and a fan. The tray forms an air chamber between the bottom of the container and the bottom and sides of the removable tray. The fan pulls air and odors across the litter bed material, through the vents of the removable tray into the air chamber, through the air chamber and through a filter pack which absorbs and/or adsorbs the odors. The air is then pulled across an optional fragrance dispenser which masks any residual odors. The litter box also has a motion sensor device which automatically shuts off the fan as the pet approaches the litter box usually about 10 feet from the litter box.

### DESCRIPTION OF THE INVENTION

In this context, the technical task underlying the present invention is to propose a deodorant device for a pet litter box and a method of eliminating odors for a litter box which overcome the aforementioned drawbacks of the prior art.

In particular, it is an object of the present invention to provide a deodorant device for a pet litter box and a method of eliminating odors for a litter box which ensure an increase in the elimination of odors.

A further object of the present invention is to provide a deodorant device for a pet litter box and a method of eliminating odors for a litter box having high operational flexibility.

A further object of the present invention is to provide a deodorant device for a pet litter box and a method of eliminating odors for a litter box which reduce the risk of the litter box being rejected by pets.

A further object of the present invention is to provide a deodorant device for a pet litter box and a method of eliminating odors for a litter box which ensure high safety for the pets which use them.

A further object of the present invention is to provide a deodorant device for a pet litter box having particularly limited dimensions.

The stated technical task and specified objects are substantially achieved by a deodorant device for a pet litter box and a method of eliminating odors for a litter box comprising the technical features disclosed in one or more of the accompanying claims.

The dependent claims correspond to possible embodiments of the invention.

### ILLUSTRATION OF THE DRAWINGS

Further features and advantages of the present invention will become more apparent from an approximate, and thus non-limiting, description of a preferred, but non-exclusive embodiment of a deodorant device for a pet litter box and a method of eliminating odors for a litter box, as illustrated in the appended drawings, in which:

FIG. 1 shows a side view of a deodorant device for a pet litter box in accordance with a possible embodiment;

FIG. 2 shows a partially exploded, sectional side view of the deodorant device of FIG. 1;

FIGS. 3-4 respectively show a front view and a rear view of the deodorant device of FIG. 1;

FIGS. 5A-5B show respective perspective depictions of a deodorant device for a pet litter box in accordance with a further possible embodiment;

FIGS. 6A-6B show respective perspective depictions of a deodorant device for a pet litter box in accordance with a further possible embodiment;

FIGS. 7A-7B show respective perspective depictions of a deodorant device for a pet litter box in accordance with a further possible embodiment;

FIGS. 8A-8B show respective perspective depictions of a deodorant device for a pet litter box in accordance with a further possible embodiment;

FIGS. 9A-9B show respective perspective depictions of a deodorant device for a pet litter box in accordance with a further possible embodiment.

### DETAILED DESCRIPTION

With reference to the accompanying figures, the reference number 1 has been used to generally designate a deodorant device for a pet litter box, which will be referred to herein as deodorant device 1.

The deodorant device 1 comprises a suction body 2 adapted to be arranged inside a pet litter box.

Preferably, the suction body 2 has a substantially symmetrical shape.

The suction body 2 has at least one inlet opening 5 and at least one outlet opening 6. In particular, the at least one inlet opening 5 is in fluid communication with the at least one outlet opening 6 to allow a passage of an airflow to be processed “F1” through the suction body 2.

Preferably, the at least one inlet opening 5 is defined by a plurality of inlet openings 5 operatively associated to allow an inflow of the airflow to be processed “F1” through the suction body 2.

Furthermore, the deodorant device 1 comprises odor eliminating means 9 activatable on the airflow to be processed “F1” at least to eliminate an odor present therein, generating a processed airflow “F2”.

Preferably, the at least one outlet opening 6 can be defined by a plurality of outlet openings 6 operatively associated to allow an outflow of the processed airflow “F2” through the suction body 2.

The deodorant device 1 further comprises a suction fan 7 at least partially, preferably entirely, housed inside the suction body 2.

In particular, the suction fan 7 is operatively associated with the suction body 2 to suck the airflow to be processed “F1” from the pet litter box through the at least one inlet opening 5 and emit the processed airflow “F2” through the at least one outlet opening 6 inside the pet litter box.

Thereby, the deodorant device 1 promotes an effective mixing of the processed airflow “F2” with the air present in the pet litter box, ensuring an increase in the odor elimination efficiency.

Advantageously, the deodorant device 1 comprises a presence sensor 15 configured to detect the presence of a pet inside the pet litter box and generate a presence signal representative of the presence of a pet inside the pet litter box. Furthermore, the deodorant device 1 comprises a control unit 14 operatively associated with the at least one presence sensor 15. According to the invention, the control unit 14 is configured to activate the suction fan 7 as a function of the presence signal, particularly after the pet has come out of the pet litter box. Furthermore, according to the invention, the control unit 14 is configured to deactivate the suction fan 7 as a function of the presence signal to prevent the operation of the suction fan 7 while an pet is present inside the pet litter box. Thereby, the present invention prevents the generation of vibrations and noises while a pet is present inside the pet litter box, reducing the risk of rejection of the litter box by pets. Furthermore, such a solution contributes to increasing the level of safety for the pet as the suction fan 7 is deactivated while the pet is present inside the pet litter box.

The control unit 14 is also operatively associated with the at least one presence sensor 15 so as to determine an entry of a pet into the pet litter box and an exit of the pet from the pet litter box. In particular, the control unit 14 can be configured to bring about a timed activation and/or deactivation of the suction fan 7 as a function of a preset time interval starting from the entry and exit of the pet.

Purely by way of non-limiting example, the control unit can determine by means of a plurality of presence signals of the presence sensor 15 the moment of the pet's entry into the pet litter box, the moment of the pet's exit from the pet litter box and, therefore, the period in which the pet stays inside the pet litter box. Thereby, the control unit can, for example, activate the suction fan 7 only when the pet has entered and subsequently left the pet litter box. The control unit can, for example, activate the suction fan 7 and deactivate it a predetermined period of time after the pet has left the litter box. Thereby, the present invention provides a deodorant device 1 having a remarkable operational flexibility.

That is, the control unit 14 can be configured to activate and/or deactivate the suction fan 7 on the basis of a plurality of operating signals, for example command signals entered by a user and/or preset.

For example, the deodorant device 1 can further comprise, at least one odor sensor configured to detect the presence of odors inside the pet litter box and generate an odor signal representative of the presence of an odor inside the pet litter box. In particular, the control unit can be operatively associated with the at least one odor sensor and be configured to activate and/or deactivate the suction fan 7 as a function of the odor signal. Thereby, the control unit 14 allows to minimise consumption by increasing the energy efficiency of the deodorant device 1.

Advantageously, the deodorant device 1 can comprise a fixing means, preferably a magnetic fixing means 8, configured to fix the suction body 2 to at least one wall of the pet litter box. In particular, the magnetic fixing means 8 guarantees an easy and intuitive reversible connection of the suction body 2 to the wall of the pet litter box, conferring particular operating flexibility and adaptability of the deodorant device 1 to the most disparate conformations of the pet litter box to which it can be applied.

For example, the fixing means 8 can comprise a first fixing element 10 connected or connectable to the suction body 2 and a second fixing element 11 connectable by magnetic interaction to the first fixing element 10 so that, during a condition of the suction body 2 being fixed to the litter box and/or cage, the wall of the litter box to which the suction body 2 is fixed is at least partly interposed between the first fixing element 10 and the second fixing element 11.

The first fixing element 10 can be connected or connectable to an anchoring portion of the suction body 2, for example, by form-fitting coupling and/or magnetic interaction.

In accordance with some possible embodiments, the suction body 2 can comprise a plurality of anchoring portions adapted to allow a reversible connection with the first fixing element 10 so as to adapt the positioning of the deodorant device 1 to the geometries and/or dimensions of the litter box to which it can be fixed, guaranteeing high operating flexibility and adaptability.

In accordance with a further advantageous aspect, the odor eliminating means 9 can comprise at least one anti-odor portion made at least partially of a material capable of eliminating odors. For example, the anti-odor portion can be made of polymeric material to which activated carbon, microcapsules, enzymes and/or the like is added. Purely by way of non-limiting example, the anti-odor portion can at least partially define the at least one inlet opening 5 and/or the at least one outlet opening 6.

Preferably, the odor eliminating means 9 comprises activated carbon configured to be activated on the airflow to be processed “F1” to generate the processed airflow “F2”.

In accordance with a possible embodiment and with particular reference to FIG. 2, the odor eliminating means 9 can comprise a sponge body 13 to which activated carbon is added. Furthermore, the spongy body 13 can be soaked or adapted to be soaked with oils and/or fluids adapted to break down and/or absorb and/or mask at least one odor, ensuring a high degree of personalisation to the deodorant device 1.

Furthermore, the deodorant device 1 can comprise a battery power means 16 configured to power at least the suction fan 7 and/or the aforementioned control unit 14, overcoming the need for a wired connection to the electrical current to allow the deodorant device 1 to be powered, giving the present invention a marked operational flexibility. For example, the battery power means 16 can be rechargeable by a USB (Universal Serial Bus) socket 19.

Furthermore, the deodorant device 1 can further comprise light signaling means 17 adapted to indicate an operating state and/or a charge level of the aforementioned battery power means 16 and/or a plurality of further possible operating parameters.

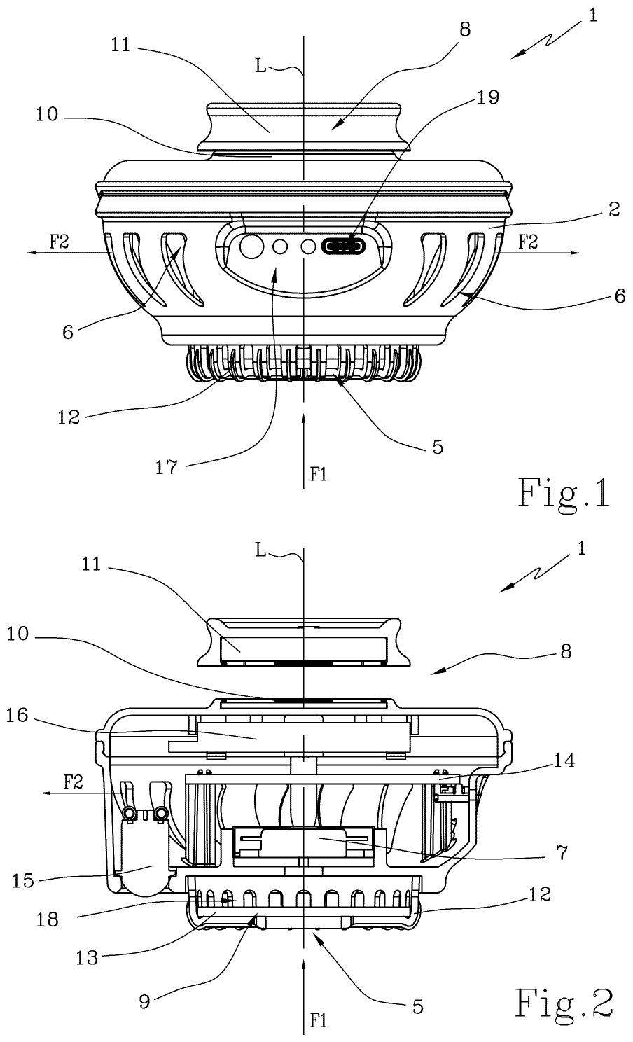

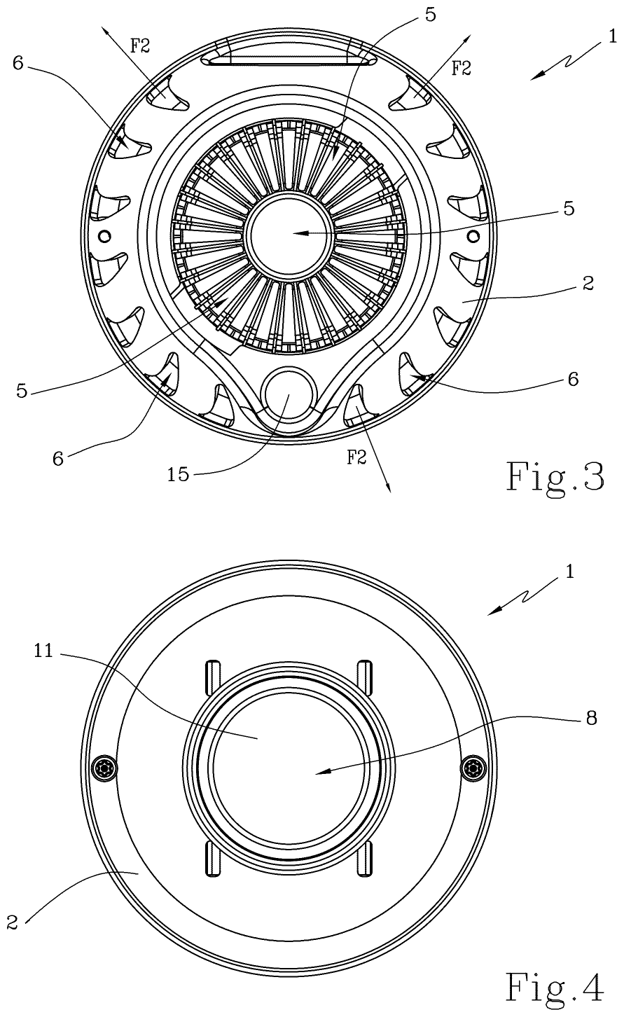

In accordance with some possible embodiments and as illustrated in FIGS. 1-4, the suction fan 7 can be configured to rotate around a rotation axis substantially parallel to a longitudinal extension axis “L” of the suction body 2. In particular, the suction fan 7 can be operatively associated with the suction body 2 to axially suck the airflow to be processed “F1” from the pet litter box through the at least one inlet opening 5 and radially emit the processed airflow “F2” through the at least one outlet opening 6 inside the pet litter box so that the processed airflow “F2” is at least partially parallel to the fixing plane of the suction body 2. Thereby, the deodorant device 1 can promote an effective mixing of the processed airflow “F2” with the air present in the pet litter box, ensuring an increase in the odor elimination efficiency. In particular, the processed airflow “F2” can be introduced inside the pet litter box along a direction substantially transverse, preferably perpendicular, to the longitudinal extension axis “L”. Furthermore, the suction body 2 can have a cylindrical and/or discoidal and/or spherical segment shape with one or two bases. Thereby, as illustrated in FIG. 3, the at least one inlet opening 5 can be arranged in a central area of the suction body 2 and the at least one outlet opening 6 can be arranged in a peripheral area of the suction body 2, promoting a substantially homogeneous radial distribution of the processed airflow “F2”. Purely by way of non-limiting example, the suction body 2 can extend for a length less than 50 millimetres along the aforementioned longitudinal extension axis “L” and for a length less than 100 millimetres in the radial direction, giving the deodorant device 1 a particular compactness which allows it to reduce the dimensions inside the pet litter box. Furthermore, the suction body 2 can comprise a removable element 12 at least partially defining the at least one inlet opening 5. Preferably, the removable element 12 defines a housing 18 adapted to at least partially house the odor eliminating means 9. Thereby, the removable element 12 can allow a replacement and/or a maintenance of the odor eliminating means 9. Advantageously, moreover, the removable element 12 can be reversibly connectable to the suction body 2 by means of form-fitting coupling, preferably a bayonet coupling, greatly facilitating the operations.

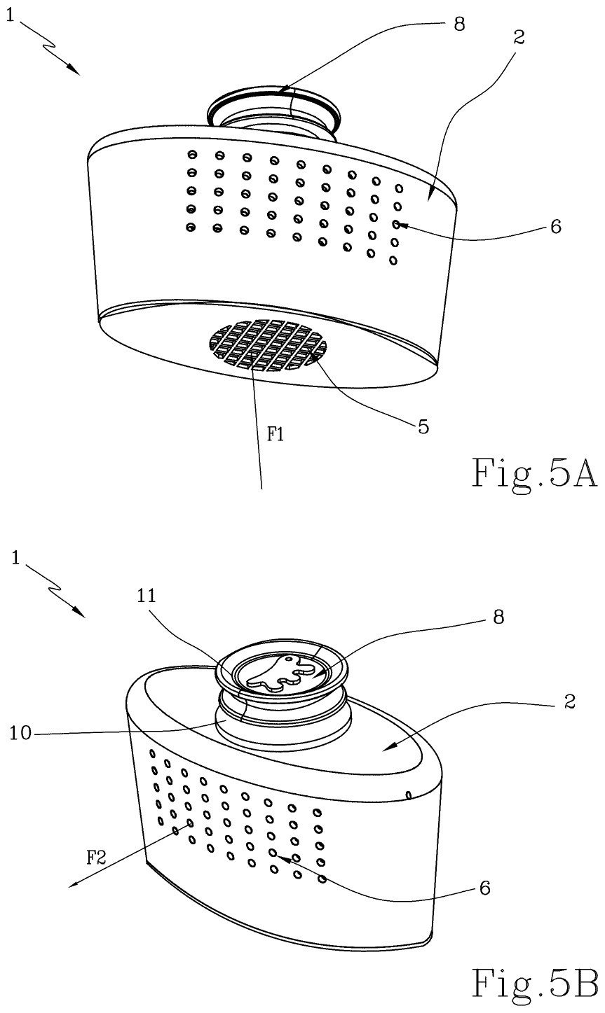

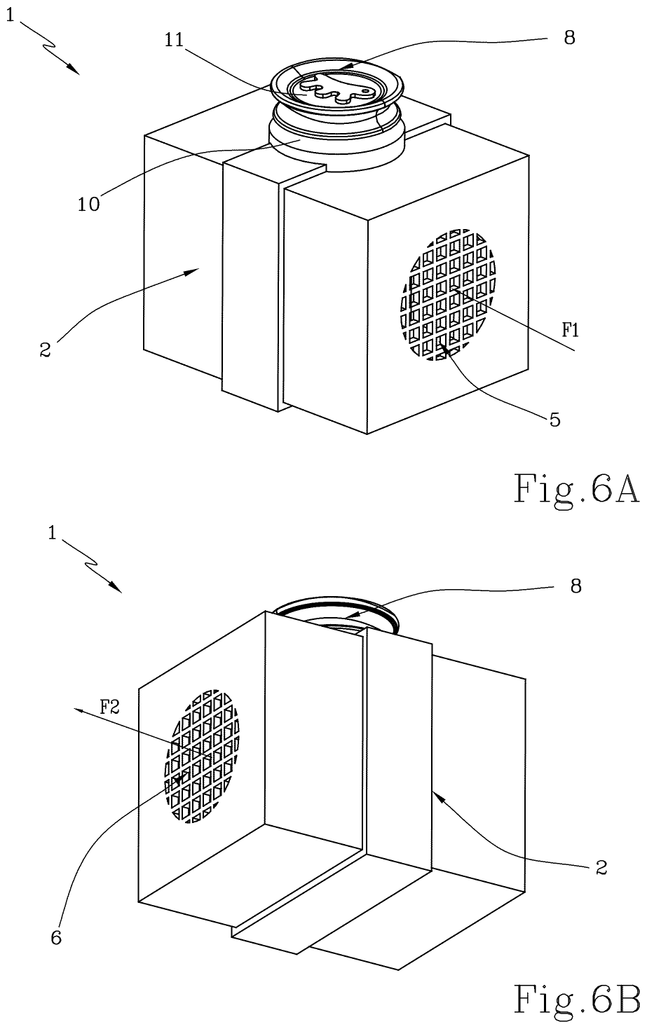

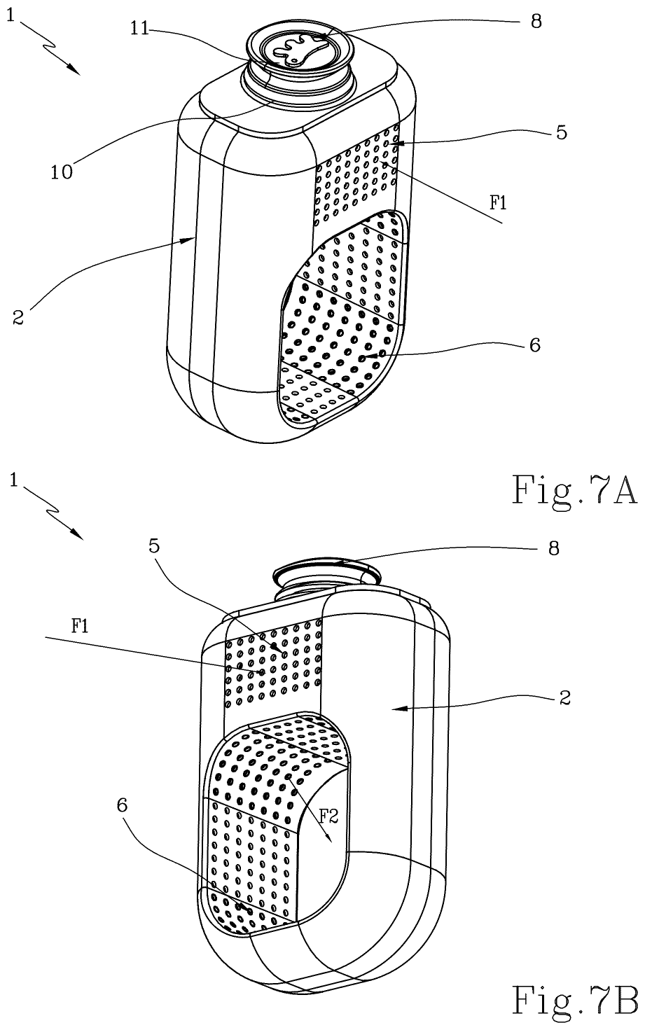

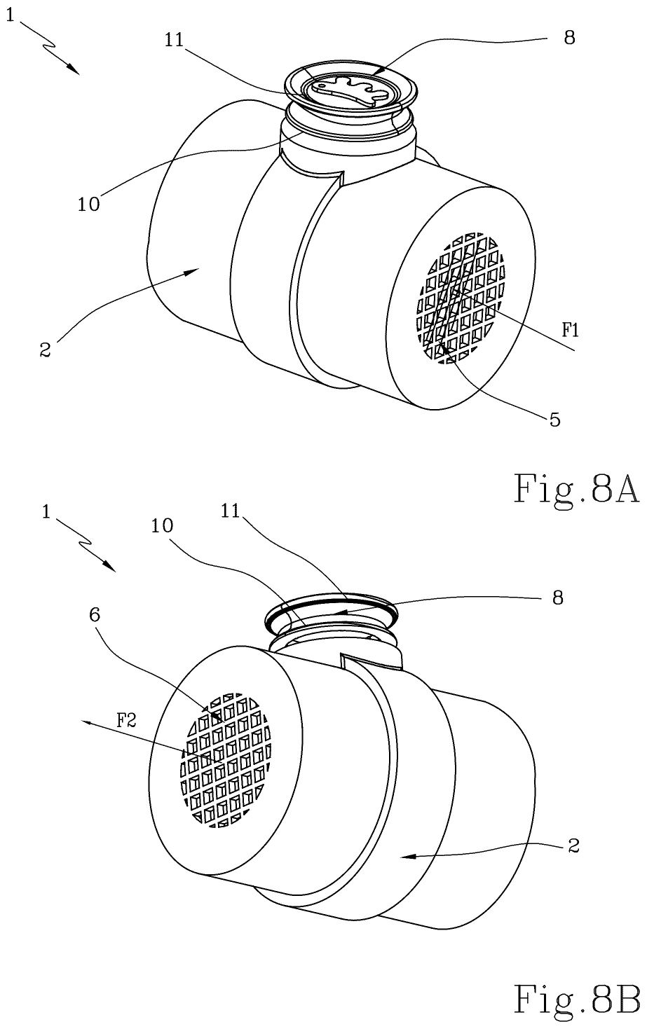

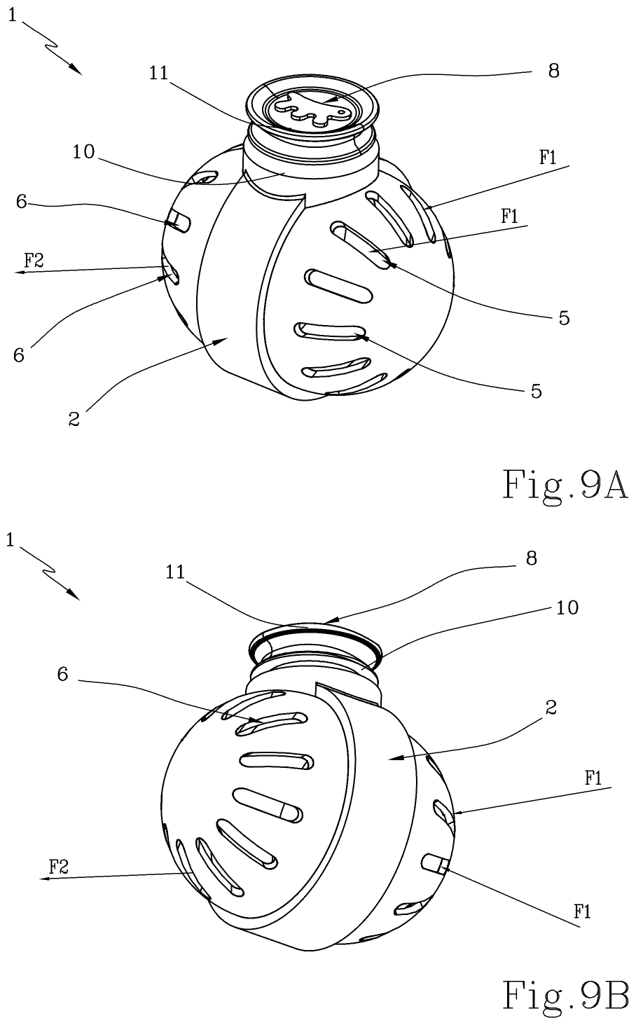

In accordance with further possible embodiments and as shown in FIGS. 5A-9B, the removable element 12 may not be provided and the processed airflow “F2” can be introduced inside the pet litter box along one or more different directions. Furthermore, the suction body 2, the at least one inlet opening 5 and/or the at least one outlet opening 6 can have different shapes without the inventive concept underlying the present invention being altered, ensuring the deodorant device 1 has a marked adaptability.

In accordance with a further aspect, the present invention relates to a pet litter box comprising a plurality of walls operatively connected to define an operating volume and a deodorant device 1 in accordance with what has been described above. Advantageously, the deodorant device 1 is reversibly connectable to a wall of the aforementioned plurality of walls so as to ensure an effective elimination of the odors present inside the litter box.

According to a further aspect, the present invention relates to a method of eliminating odors for a pet litter box comprising the step of drawing in an airflow to be processed “F1” present inside a pet litter box and a step of eliminating at least one odor present in the airflow to be processed “F1” thereby generating a processed airflow “F2”.

Furthermore, the method comprises a step of emitting the processed airflow “F2” into the pet litter box.

Additionally, the method comprises a step of detecting an entry of an pet into the pet litter box and the step of blocking the drawing in of the airflow to be processed “F1” and/or the emission of the processed airflow “F2” as a function of said detection to prevent the drawing and/or emission while an pet is present inside the pet litter box. Thereby, the present invention allows to overcome the problem of litter box rejection by a pet, for example a cat, ensuring that while the pet is present inside the litter box, the pet is not disturbed or frightened by adverse events or situations such as noises, vibrations, electrostatic currents and/or the like.

Furthermore, the method comprises the step of detecting an entry of an pet into the pet litter box and/or an exit of the pet from the pet litter box. In particular, the method can comprise a step of performing a timed suction as a function of a preset time interval starting from the entry and/or exit of the pet.

In accordance with some possible embodiments of the present invention, the method can comprise the step of drawing in the airflow to be processed “F1” along a transverse direction, preferably perpendicular, to at least one wall of an pet litter box and/or the step of radially emitting inside the pet litter box the processed airflow “F2” in a direction at least partially parallel to the aforementioned wall. Furthermore, the method can comprise a step of conferring to the processed flow “F2” a tangential speed component and/or a speed component directed towards the aforementioned wall so as to promote a mixing of the processed flow “F2” with the air present in the litter box and/or cage.

Preferably, at least one of the steps of the method is achieved by means of a deodorant device 1 in accordance with what is described above.

It is thus noted that the present invention achieves the proposed objects by making a deodorant device for pet litter boxes capable of increasing the efficiency in eliminating odors thanks to the presence of a presence sensor and a control unit operatively associated to deactivate the suction fan while an pet is present inside the pet litter box.

1. A deodorant device for a pet litter box, the device comprising:
a suction body having at least one inlet opening and at least one outlet opening, the at least one inlet opening being in fluid communication with the at least one outlet opening to allow the passage of an airflow to be processed (F1) through the suction body;
an odor eliminating means activatable on the airflow to be processed (F1) at least to eliminate an odor present therein, generating a processed airflow (F2);
a suction fan at least partly housed in the suction body, the suction fan being operatively associated with the suction body so as to draw in from the pet litter box the airflow to be processed (F1) through the at least one inlet opening and emit said processed airflow (F2) through the at least one outlet opening;
at least one presence sensor configured to detect the presence of a pet inside the pet litter box and generate a presence signal representative of the presence of the pet inside the pet litter box; and
a control unit operatively associated with the at least one presence sensor, the control unit being configured to perform at least one of: activate the suction fan as a function of the presence signal and deactivate the suction fan as a function of said presence signal.

2. The deodorant device of claim 1, wherein the control unit is operatively associated with the at least one presence sensor so as to determine an entry of the pet into the pet litter box and an exit of the pet from the pet litter box; and wherein the control unit is configured to bring about a timed activation and/or deactivation of the suction fan according to a preset time interval starting from the entry and exit of the pet from the pet litter box.

3. The deodorant device of claim 2, comprising a magnetic fixing device configured to fix the suction body to at least one wall of the pet litter box.

4. The deodorant device of claim 3, wherein said magnetic fixing device comprises a first fixing element connected to the suction body and a second fixing element connectable by magnetic interaction to the first fixing element so that, during a condition of the suction body being fixed to the litter box, one wall of the litter box is at least partly interposed between the first fixing element and said second fixing element.

5. The deodorant device of claim 4, wherein the suction body comprises a plurality of anchorage portions adapted to enable a reversible connection with the first fixing element, the anchorage portions being configured to create a form-fitting coupling with the first fixing element.

6. The deodorant device of claim 1, wherein said odor eliminating means comprises at least one anti-odor portion made at least partially of a material capable of eliminating odors, the anti-odor portion at least partly defining the at least one inlet opening and/or the at least one outlet opening.

7. The deodorant device of claim 1, wherein the odor eliminating device comprises a spongy body with added activated carbon, the spongy body being adapted to be soaked with oils and/or fluids adapted to eliminate and/or absorb and/or mask at least one odor.

8. The deodorant device of claim 1, comprising a battery configured to power the suction fan.

9. The deodorant device of claim 1, comprising at least one odor sensor configured to detect the presence of odors inside the pet litter box and to generate an odor signal representative of the presence of an odor inside the pet litter box; and wherein the control unit is operatively associated with the at least one odor sensor and configured to activate and/or deactivate the suction fan as a function of the odor signal.

10. A method of eliminating odors for a pet litter box comprising the steps of:
detecting a presence of a pet inside the pet litter box;
preventing a first airflow to be drawn inside the pet litter box while the pet is present inside the pet litter box;
detecting exit of the pet from the pet litter box; and
generating, by means of a suction fan placed inside the pet litter box, a second airflow inside the pet litter box, thereby eliminating at least one odor which is present inside the pet litter box.

11. The method of claim 10, further comprising maintaining the airflow generated by the suction fan for a predetermined time interval controlled by a control unit starting from the exit of the pet from the pet litter box.

12. The method of claim 10, further comprising detecting the presence of an odor inside the pet litter box and activating the airflow by the suction fan while the pet is absent from the litter box.
